(19) United States
(12) Patent Application Publication
(10) Pub. No.: US 2025/0282575 A1
(43) Pub. Date: Sep. 11, 2025

(54) MEASURING STRIP FOR ELEVATOR SYSTEMS

(71) Applicant: Felix Grimm, Rielasingen (DE)

(72) Inventor: Stephan Rohr, Triesen (LI)

(73) Assignee: Felix Grimm, Rielasingen (DE)

(21) Appl. No.: 18/572,443

(22) PCT Filed: Jun. 23, 2021
(86) PCT No.: PCT/EP2021/067237

§ 371 Date: Aug. 14, 2024

(51) Int. Cl. B66B 1/34; G01D 5/30

(52) U.S. Cl. CPC B66B 1/3492; G01D 5/305; G01D 2205/10

(57) ABSTRACT

The invention at hand relates to a tape measure for determining the position of an elevator car (42) in an elevator shaft (41), the tape measure being disposable vertically in the elevator shaft and preferably so as to extend across at least two floors (43a, 43b, 43c, 43d), the tape measure having a tape-shaped base body (1) and optical coding (2). The tape-shaped base body (1) is made of a textile material and in that the optical coding (2) is inserted in the base body or is applied on a surface (1a) of the base body.

### BACKGROUND OF THE INVENTION

The invention at hand relates to a tape measure or a measuring element for determining the position of an elevator car in an elevator shaft and a measuring system having the tape measure.

Devices for identifying the position of an elevator car of an elevator installation are known from the state of the art. These devices serve to provide information on the current position of the elevator car along the elevator shaft or the corresponding elevator rails in the shaft. Aside from simple position encoders, such as shaft switches, which provide feedback on a current elevator-car position at predefined positions in the elevator shaft, incremental position encoders also exist which allow determining the precise position at any position in the shaft.

EP 3 231 753, for example, discloses an elevator installation having a tape measure which is disposed in the elevator shaft and serves to determine the position of the elevator car in the elevator shaft. The tape measure has optical coding in the form of consecutive position patterns, in particular 2D codes, for measuring length. At the elevator car, a sensor apparatus is fastened which comprises an illumination source and a sensor comprising a detection field for detecting the tape measure and for evaluating a corresponding elevator-car position. A tape measure of this kind is generally designed as a steel tape, on which the optical code is printed and which is enclosed by a plastic layer.

Likewise, systems are known which are based on magnetic influence or induced alternating fields and in which a coding is inserted in a steel tape or is coupled in a magnetically influenceable manner.

DE 10 2004 043 099 A1 discloses, for example, a device for determining the position of an elevator car, electromagnetic alternating fields being inserted in an electrically conductive rope spanned parallel to the elevator rails, the electromagnetic alternating fields being influenced by a magnet disposed at the elevator car. An evaluation apparatus not disposed at the elevator car detects the elevator-car position by registering a deflection caused by the magnet at the elevator car.

EP 0 927 674 A1 discloses a reader head fastened at the elevator car or the vehicle for evaluation of a magnetically coded tape spanned along a rail, the reading head having magnetically sensitive sensors for determining the position by means of coding in the rape.

Problems with the known devices and systems are maintaining a reliable position identification over several years or decades. In particular, due to environmental influences, such as dust, moisture, ferroconcrete abrasions etc., the position tapes suspended in the shaft can become soiled over the years, the steel tape can rust or layers can peel from multilayer tapes. Other problems are maintaining a defined arrangement of the tape in the elevator shaft while ensuring a reliable position identification, in particular in new-builds which are still in the process of settling, i.e., experience compression due to material loads, changes in the building material etc., whereby a warping and/or bending of and, in the worst case, damage to the tape can arise. This can be addressed by a manual readjustment or by tensioning and/or mounting apparatuses for the tape in the elevator shaft. The latter, however, can lead to a significant cost increase and increase the susceptibility to failure.

### SUMMARY OF THE INVENTION

The object of the invention is to provide an improved measuring element, in particular a tape measure, and a corresponding measuring system, which both address the disadvantages of the state of the art as mentioned above. In doing so, a simple and inexpensive producibility and preferably a simple installation in the elevator shaft is to be enabled aside from a reliable registration of an elevator-car position in the elevator shaft. This object is attained by the subject matter of the independent claims. The dependent claims provide advantageous embodiments of the invention at hand. Moreover, the invention addresses further problems, as described in the following description.

In a first aspect, the invention relates to a tape measure for determining the position of an elevator car in an elevator shaft, the tape measure being disposable vertically in the elevator shaft and preferably so as to extend across at least two floors, the tape measure having a tape-shaped base body and optical coding, the tape-shaped base body being made of a textile material and the optical coding being inserted in the base body or being applied on a surface of the base body.

In contrast to the known prior art, the tape measure for determining the position of the elevator car is now no longer made of metal, such as iron or in particular steel, but consists of a textile base body in or on which the position coding is inserted or applied. Through this, a lighter overall weight of the tape, on the one hand, and extended application possibilities, on the other hand, are attained. In particular, the use of the tape measure is suitable in rough environmental conditions, such as salt-water exposure, such as for determining the position on ships, wind installations, dockyards, cranes etc. Additionally, the textile base body has a higher tape expansion and flexibility than the known steel tape measures, thus simplifying the installation and the arrangement in an elevator shaft. Furthermore, the tape measure according to the invention also allows simpler and faster production. In particular, in contrast to the state of the art, no complex adhesion of a steel tape and another layer made of a different material to be disposed thereon, such as a rubber mixture, is required, the layer subsequently being magnetized or printed.

The tape-shaped base body is weaved or knitted of preferably a textile material, in particular textile fibers. Alternatively, the base body can also be spun or stitched.

The tape-shaped base body preferably has a constant width of 5 mm to 30 mm, more preferably of 8 mm to 25 mm, further preferably 8 mm to 14 mm, perpendicular to the length of the tape measure. The tape measure preferably has a thickness of 0.3 mm to 5 mm, more preferably of 0.5 mm to 3 mm and particularly preferably of 0.5 mm to 2 mm. The length of the tape-shaped base body is adapted to the corresponding elevator shaft in which the base body is to be disposed. Exemplarily, the base body can have a length of 15 m in a five-story building.

Presently, optical coding is understood to be coding which can be read or sampled by means of an assigned optical sensor.

The coding can have openings inserted in the base body. They can be variably formed along the tape-measure length and/or along the tape-measure width regarding shape and/or arrangement. In this instance, the coding can comprise several openings of a different shape and/or size subsequent along the tape-measure length. In particular, the openings can be rectangular and/or round and differ in their length and/or width for forming a code marking pattern.

The openings can be punched in the textile base body or be worked, in particular weaved or knitted, in the textile base body during the production method.

In a preferred embodiment, the base body has at least one accommodation opening and in particular one pocket for accommodating a preferably reflective, in particular retroreflective, core element. In this case, the accommodating opening or pocket is formed in the interior of the base body and is accessible by means of at least one, in particular slit-shaped, opening. In this context, the core element is preferably disposable or disposed in such a manner in the interior of the base body that openings formed in the base body are covered by the core element. Owing to this, an optically easily detectable reflection can be attained in the corresponding openings, which is easily readable using an optical sensor disposed in particular on one side of the tape measure.

The base body can have several and further preferably a plurality of pockets of this kind for accommodating and securing core elements disposable therein. The pockets can have a depth or length along the tape-measure length, which covers a plurality of openings in the tape-measure length. For instance, a corresponding pocket can have a depth of several meters for mounting a correspondingly long core element.

The pockets having corresponding openings can be disposed regularly along the tape-measure length. Alternatively, the pockets can be disposed only at predefined sections in the tape measure. The pockets can extend merely across a partial or the entire tape-measure width. For instance, the pockets can also extend across merely a predefined line of the tape measure. The pockets can be configured for accommodating a core element and/or a different information carrier or an identification object, such as an RFID tag or chip readable by an assigned sensor arrangement.

Alternatively, the tape measure can be double-layered, a continuous, in particular slit-like opening being formed for accommodating a core element in the interior of the textile base body. The continuous opening can extend essentially across the entire length of the tape measure in this context.

As described above, the core element can be reflective in this context. For instance, the core element can be made of a metal. Alternatively, the core element can be made of a plastic material having a reflective surface. In this context, the surface can also be printed or coated with a reflective layer. Alternatively, the core element can have a uniformly patterned surface, such as having a continuous striped or checked pattern.

In another embodiment, the core element itself can have an optical coding which is readable by an optical sensor assigned to the tape measure. The core element can be formed in such manner in this instance that it forms an adaptive coding in interaction with openings disposed in the tape measure. For instance, the openings provided at the pockets can have a repetitive hole or opening pattern along the tape length. In this context, the core element disposable in the pockets can provide coding of the tape measure in interaction with the repetitive hole or opening pattern. For instance, the core element can be merely partially retroreflective, in particular sections or sectors thereof can be retroreflective, the remaining core element being non-reflective and/or unicolor.

In another exemplary embodiment, the optical coding can be formed by specifically disposed and/or formed warp threads extending in particular longitudinally to the tape-measure length and/or weft threads extending in particular along the tape-measure width. The specifically disposed and/or formed warp threads and/or weft threads of the coding preferably have a different structure and/or coloration than the remaining base body of the tape measure. This allows inserting, in particular weaving, an optically readable coding in the textile base body by means of the specifically disposed warp threads and/or weft threads. The warp threads and/or weft threads can consist in particular of a textile material structured or dyed differently to the remaining textile base body, thus providing a sufficient contrast to the textile base body, the contrast being detectable by means of an assigned optical sensor. For instance, the corresponding optical coding or a desired code marking pattern can be formed by differently colored, transparent or reflective thread. Preferably, for example, the previously described recesses or holes in the tape measure can be formed in the tape measure via a transparent thread. This provides a transparent code marking pattern in the tape measure while the tape-measure base body has an essentially homogeneous structure.

In an alternative embodiment, the optical coding can be printed or glued on the base body. For instance, the coding can be printed on the base body by means of a textile printing method.

The optical coding can comprise several consecutive position patterns, in particular having barcodes, data matrix codes or QR codes. They can be formed in the base body by the previously described openings in the tape-measure base body and/or by specifically disposed warp threads and/or weft threads, for example. The coding can further form or comprise an alternating, sequential or absolute position coding. The corresponding coding, in particular in the form of barcodes, data matrix codes or QR codes, can be formed or disposed on the tape measure in one lane, two lanes or multiple lanes.

In a preferred embodiment, the tape measure has a first surface and an opposite second surface, the first and the second surface each having preferably different coding. This allows increasing the information density of the tape measure. For reading or sampling, a corresponding sensor can be disposed on either of two sides of the tape measure. When forming the coding in the form of openings inserted in the base body, a core element is preferably disposed in the interior of the base body, the core element covering openings formed in both the first and second surface.

In a preferred embodiment, the coding is disposed or formed on a surface of the tape measure in a lane which extends along the tape-measure length and preferably extends across the entire tape-measure width. In another embodiment, the coding has at least two lanes on a surface of the tape measure, the two lanes preferably extending along the tape-measure length. The at least two lanes can have coding or a code marking pattern different to each other. For instance, a first lane can comprise or form an incremental or alternating coding and an adjacent second lane can comprise or form an absolute position coding. Furthermore, the tape measure can also have more than two, in particular at least three or four, lanes, in each of which coding is disposed or formed.

The tape measure according to the invention is preferably single-layered, i.e., is made of a contiguous, tape-shaped textile base body. Alternatively, the tape can be double-layered, the first and second layer being able to be connected to each other by forming at least one pocket or opening extending along the longitudinal direction at both longitudinal edges of the tape measure. In this context, a tape-like textile base body can be folded at a longitudinal edge during production and, for example, be connected to each other at two superjacent edges of the opposite sides by forming an interior or opening extending along the length.

The tape measure can have a functionality and/or signal line worked, in particular weaved or knitted, along the length and preferably formed to not absorb force. They can serve for transmitting signals along the tape measure and be contacted at intended contact points by means of external components for conducting signals. The at least one functionality and/or signal line is preferably made of a conductive material, such as a metal wire, which can be inserted, in particular weaved, in the textile base body. This allows the tape measure to additionally serve as an optimized carrier element for functionality and/or signal lines of an elevator control.

Furthermore, the tape measure can provide additional code marking pattern sections for providing a predefined absolute position, in particular an inspection-end switch or a shaft-end switch. This can be formed by a unique and predefined absolute code marking pattern at a corresponding position in the tape measure. Alternatively, a sequential or incremental code marking pattern formed in the tape measure can be covered at the corresponding tape-measure position by an applied covering. In this context, sections of the tape covering consisting of, for example, textile material can be applied at the corresponding position when installing the system in the elevator shaft.

In another aspect, the invention relates to a measuring system having a tape measure as described above and a sensor arrangement having at least one optical sensor for reading the optical coding of the tape measure.

For this purpose, the sensor arrangement is intended for the fixed positioning at an elevator car of an elevator system. The elevator car with the sensor arrangement attached thereto moves along the tape measure in the elevator shaft, a determination of the position of the elevator car in the elevator shaft becoming possible via the interaction of the tape measure and corresponding sensor arrangement.

The sensor arrangement is preferably disposed to forward the position, speed and/or acceleration of an assigned elevator car by reading the tape measure at a superordinate control. This preferably takes place by reading or sampling the optical coding when moving the sensor arrangement along the tape measure. The sensor arrangement and/or the control can have a correspondingly configured microcontroller for this purpose.

The optical sensor of the sensor arrangement can have a barcode scanner, a digital camera as a camera registration element, a light barrier or the like. The optical sensor can have a light source integrated therein or provided externally.

The sensor arrangement can have at least two optical sensors disposed at an offset to each other along the tape-measure length and preferably disposed parallel to the length of the tape measure. The optical sensors are preferably essentially oriented perpendicular on a tape-measure surface.

The sensor arrangement can further comprise different sensors and thus combine different evaluation methods. For instance, the sensor arrangement can have a light-barrier sensor for evaluating holes disposed in the tape measure or transparent sections. Additionally, the sensor arrangement can have a barcode scanner or a camera for reading or sampling reflected sections of the code marking pattern in the tape measure.

Alternatively or additionally, the sensor arrangement can have at least two optical sensors for reading coding on a first and second surface of the tape measure. The optical sensors are oriented on opposite surfaces of the tape measure in this context. The opposing sensors can be disposed directly opposite or be disposed at an offset to each other along the tape-measure length.

Additionally, the sensor arrangement can have an RFID sensor, which is configured for reading an RFID chip or tag disposable in or at the tape measure.

In another aspect, the invention relates to an elevator system having an elevator shaft and an elevator car displaceable therein and having a measuring system for determining the position of the elevator car in the elevator shaft, as described above.

### BRIEF DESCRIPTION OF THE DRAWINGS

Further advantageous details of the invention are derived from the following description of preferred exemplary embodiments and by means of the figures.

FIG. 1 shows a schematic lateral view of a preferred exemplary embodiment of an elevator system according to the invention;

FIG. 2a, 2b show a view of preferred embodiments of the tape measure according to the invention;

FIG. 3 shows a view of another preferred embodiment of the tape measure;

FIG. 4 shows a cut view of another preferred embodiment of the tape measure;

FIG. 5 shows a perspective lateral view of a measuring system according to the invention;

FIG. 6 shows a view of another preferred embodiment of the tape measure according to the invention; and

FIG. 7 shows a view of another preferred embodiment of the tape measure according to the invention having regularly disposed pockets in a lane of the tape measure.

### DETAILED DESCRIPTION

In the figures, the same elements and elements having the same function are referred to with the same reference numerals.

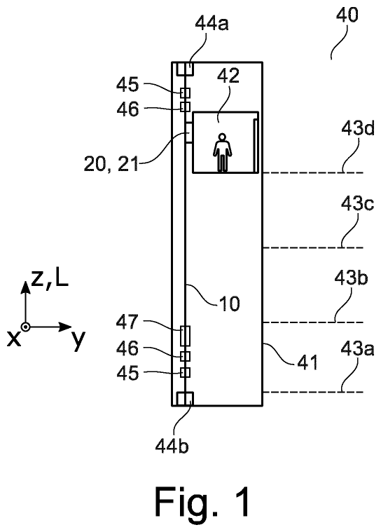

FIG. 1 shows an elevator system 40 having an elevator shaft 41 extending over several floors 43a-d, for example of a building, ship, crane arm or high-rack storage, and an elevator car 42 displaceable therein. The system additionally has generally known drive elements (not shown), which enable a selective displacement of elevator car 42 in elevator shaft 41. To identify the position of the elevator car in elevator shaft 41, elevator system 40 has a measuring system 30 (see FIG. 5), which is described in more detail below and has a tape measure 10 disposed in elevator shaft 41 and a sensor arrangement 20 interacting therewith, disposed at elevator car 42 and having an optical sensor 21. Tape measure 10 extends vertically preferably through the entire elevator shaft 41 and is secured in its position in the elevator shaft with the aid of intended fastening elements 44a, 44b.

Tape measure 10 can at the least allow providing an inspection-end switch 45 and/or a shaft-end switch 46 aside from a detailed position identification. Furthermore, tape measure 10 can be configured to provide coding of parameters, in particular operational parameters of elevator system 40, in a predefined section 47, these parameters being taught upon initial operation, for example, or being able to be (re)taught when exchanging sensors. The coding of the operational parameters can be executed by means of an optical coding disposed in predefined section 47 and described in further detail below or by means of a different coding element, such as an RFID chip, on which operational parameters, such as maximum speed (Vₘₐₓ), shaft-end delay (ETSL) etc., are stored.

An inspection-end switch 45 and/or a shaft-end switch 46 can be provided by, for example, at least partially covering optical coding 2 in tape measure 10, which is described in more detail below.

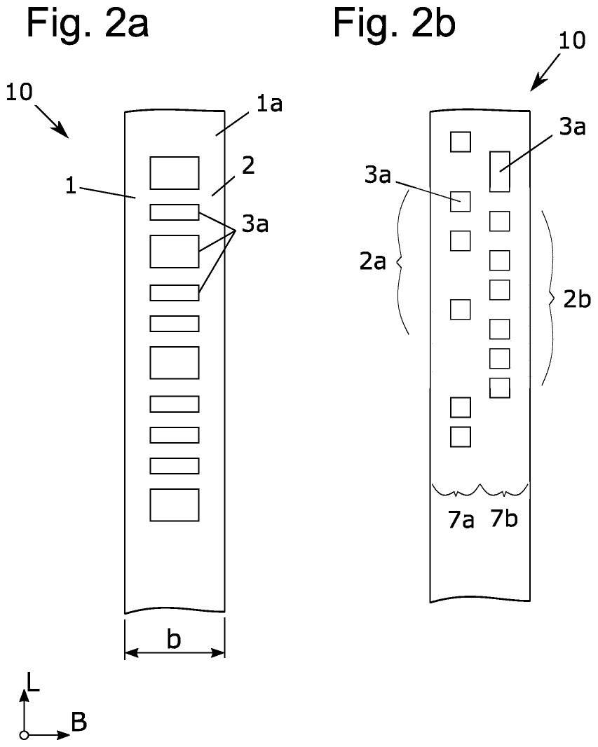

FIG. 2a shows a schematic view of a preferred embodiment of tape measure 10 according to the invention. Tape measure 10 comprises a tape-shaped base body 1 made of textile material. It is made of a suitable textile thread, consisting of one or more textile fibers, formed to a longitudinal tape preferably by means of weaving or knitting. In the shown embodiment, the textile tape is made of a plurality of warp threads and weft threads. In this context, the warp threads extending in the longitudinal direction absorb the tape tension.

Tape measure 10 preferably has a constant width b of 5 mm to 30 mm, more preferably of 8 mm to 25 mm, further preferably of 8 mm to 14 mm, perpendicular to length L of tape measure 10. A length L of tape measure 10 is adapted to the corresponding length of elevator shaft 41.

Tape measure 10 has optical coding 2, which is inserted in base body 1 or is applied to a surface 1a of base body 1. In the present embodiment, coding 2 is formed by openings or recesses 3a inserted in the base body or formed therein. In this context, openings 3a are preferably weaved or knitted in base body 1 when producing the tape measure. Openings 3a can alternatively be worked in the textile base body by punching or burning. Optical cording 2 forms a predefined pattern, in particular position pattern, in base body 1, which is readable by sensor arrangement 20 of measuring system 30.

As depicted, coding 2 can comprise rectangular recesses having a different length in tape-measure length L, for example. They can form an optically detectable barcode, for example. The pattern shown through openings 3a in FIG. 2a is merely exemplary. Openings 3a can, in particular, have an alternative geometric form and/or a corresponding extension different in tape-measure length L and/or in tape-measure width B. Furthermore, coding 2 can also have several openings 3a disposed and/or formed adjacent to each other in the tape-measure width. Openings 3a can, in particular, form a data matrix code. The coding shown in FIG. 2a is advantageously a one-lane coding along tape-measure length L. Alternatively, a multi-lane coding, in particular having at least two or three lanes along the tape-measure length, can be intended for this purpose.

FIG. 2b shows a preferred embodiment of the tape measure having two lanes 7a, 7b, which are disposed adjacent to each other along length L and each have an optical coding 2a, 2b, each of which is formed by openings 3a. For this purpose, pieces of information independent of each other can be coded in a first and second lane 7a, 7b, which increases the information density of the tape measure.

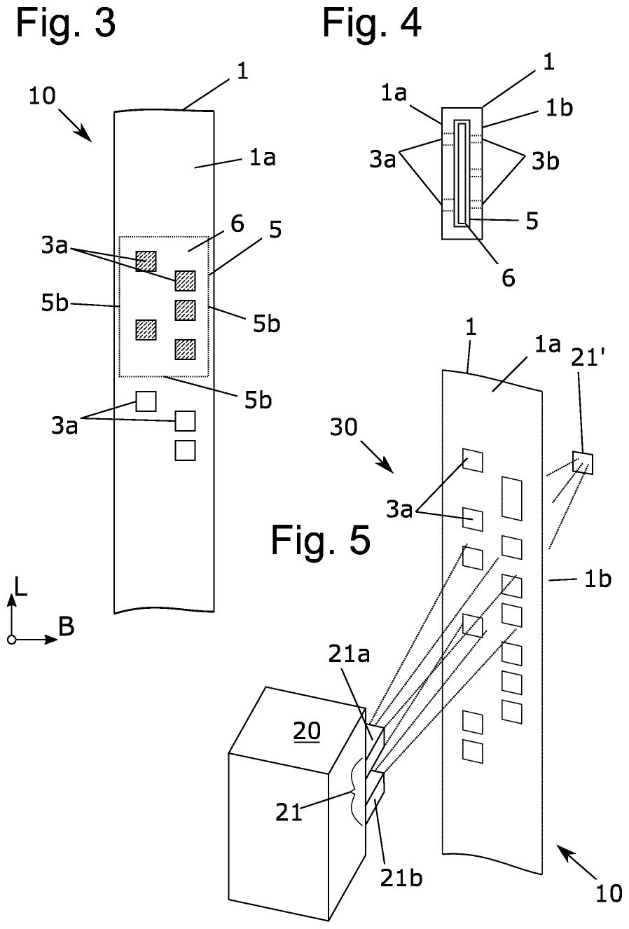

FIG. 3 shows another preferred embodiment of tape measure 10, the tape measure having at least one pocket 5 which is worked in base body 1. In this context, pocket 5 can have an in particular slit-like opening 5a extending along tape-measure width B. Furthermore, pocket 5 can comprise a circumferential inner edge 5b preferably closed toward the exterior. Pocket 5 is preferably formed in such a manner for accommodating a core element 6 that openings 3a formed in a surface 1a of base body 1 are covered by core element 6. In this case, core element 6 is preferably reflective, whereby the optical detectability of openings 3a can be simplified by an assigned sensor.

Base body 1 can have several pockets 5 which are subsequent along length L and are designed for accommodating a corresponding core element 6. A corresponding pocket preferably has an extension along tape-measure width B, which corresponds to at least 50%, further preferably at least 75%, of the width of the tape measure. Furthermore, pocket 5 can extend along the entire length of tape measure 10. This allows providing an essentially double-layered base body of the tape measure.

FIG. 4 shows a cut view of another embodiment of tape measure 10, which has a pocket 5 analogous to the embodiment according to FIG. 3. Aside from openings 3a in first surface 1a, the tape measure has additional openings 3b in an opposite surface 1b of the tape measure. They form more coding on opposite surface 1. Core element 6 disposed in pocket 5 covers corresponding openings 3a, 3b on opposite surface 1a, 1 b in this context. Core element 6 has a surface which is reflective on both sides.

As stated in reference to FIG. 3, pocket 5 can extend along a substantial length L of the tape measure, in particular across the entire tape-measure length, and form an essentially double-layered base body 1 in this context.

FIG. 5 shows a sensor arrangement 20 for interacting with tape measure 10. Sensor arrangement 20 is formed on an elevator car 42 of an elevator system 40 for an arrangement secure in position (see FIG. 1). Sensor arrangement 20 comprises at least one optical sensor 21 directed at tape-measure surface 1a. Sensor 21 can have at least two sensors 21, 21b disposed parallel to the extension of the tape measure. Optical sensor 21 can, for instance, have camera registration elements and, optionally, an assigned light source.

Sensor arrangement 20 can additionally comprise another optical sensor 21′, which is directed at a second surface 1b of tape measure 10 in order to read an optical coding disposed thereon.

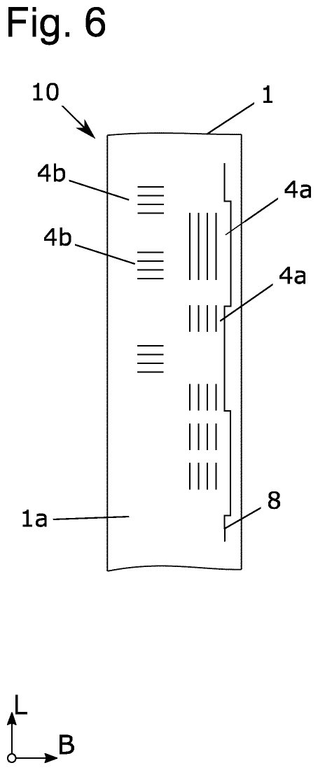

FIG. 6 shows another preferred embodiment of tape measure 10 according to the invention. In this context, optical coding 2 is formed in base body 1 via specifically disposed and/or formed warp threads 4a extending in particular parallel to tape-measure length L and/or via weft threads 4b extending in particular along tape-measure width B. The arrangement shown merely schematically in FIG. 6 forms an optical code marking pattern, which can be read by an assigned optical sensor 21. Optical coding 2 can comprise or form, for instance, a barcode, a data matrix code or a QR code in this instance.

Warp threads and/or weft threads 4a, 4b can have a different structure and/or coloration than remaining textile base body 1 of tape measure 10. In particular, the threads can consist of at least partially transparent or reflective thread. This allows providing an optical coding using warp threads and/or weft threads while retaining a homogenous tape-measure body, i.e., without providing additional openings or recesses. This allows preventing the risk of soiling or snagging objects such as shavings, screws or the like in the tape measure and the inherent risk of an impaired readability or of a torn tape.

Tape measure 10 can optionally have at least one functionality and/or signal line 8, which is worked, in particular weaved or knitted, in length L, is preferably formed to not absorb force and is configured to be made of a conductive material, such as a metal wire. It can serve for transmitting signals along the tape measure and be contacted at intended contact locations by means of external components for signal transmission.

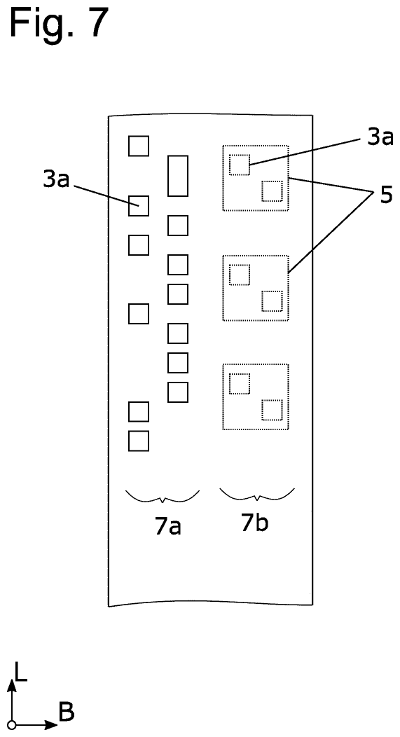

FIG. 7 shows another preferred embodiment of tape measure 10 having at least one first lane 7a having optical coding, in particular forming sequential, incremental or absolute optical coding 2. It can be formed via openings in tape-measure base body 1 or by specifically disposed warp threads and/or weft threads 4a, 4b as described above. Moreover, tape measure 10 has at least one second lane 7b, which preferably comprises pockets 5 disposed regularly along tape-measure length L, pockets 5 merely extending across a width of lane 7b. They can be formed for accommodating a previously described core element 6 and/or a different information carrier, such as an RFID chip or tag. An opening of the pockets can extend along the tape-measure length or along the width of the tape measure in this context. Pockets 5 can at least have openings or recesses 3a formed to a surface 1a of the tape measure. They can also be formed evenly in each pocket 5. By using individual core elements 6 having either a partially reflective and/or non-reflective surface, a desired coding 2 or a desired position, such as an inspection-end switch or a shaft-end switch, can be generated or formed in corresponding pockets 5 or at the corresponding position of tape measure 10 (see FIG. 1).

The embodiments described above are merely exemplary, with the invention not being limited to the embodiments shown in the Figures in any manner. In particular the shape, size and arrangement of the coding in the textile tape base body can be formed in a different manner to the embodiments shown.

Reference Numerals

| | |
|---|---|
| 1 | base body of tape measure |
| 1a, 1b | first, second surface of tape measure |
| 2 | optical coding |
| 3a, 3b | opening, recess |
| 4a, 4b | warp thread, weft thread |
| 5 | pocket |
| 5a | opening |
| 5b | circumferential inner edge |
| 6 | core element |
| 7a, 7b | first, second lane |
| 8 | signal line |
| 10 | tape measure |
| 20 | sensor arrangement |
| 21, 21a, b | optical sensor |
| 21′ | optical sensor |
| 30 | measuring system |
| 40 | elevator system |
| 41 | elevator shaft |
| 42 | elevator car |
| 43a-d | floors |
| 44a, 44b | fastening element |
| 45 | inspection-end switch |
| 46 | shaft-end switch |
| 47 | predefined tape-measure section |

1. A tape measure for determining the position of an elevator car (42) in an elevator shaft (41), the tape measure being disposable vertically in the elevator shaft, the tape measure having a tape-shaped base body (1) and optical coding (2), wherein the tape-shaped base body (1) is made of a textile material and the optical coding (2) is inserted in the base body or is applied on a surface (1a) of the base body.

2. The tape measure according to claim 1, wherein the tape-shaped base body (1) is weaved or knitted of a textile material.

3. The tape measure according to claim 1, wherein the coding (2) has openings (3a, 3b) which are inserted in the base body (1) and are variably formed along the tape-measure length (L) regarding shape and/or arrangement.

4. The tape measure according to claim 1, wherein the optical coding (2) comprises several consecutive position patterns having barcodes, data matrix codes or QR codes.

5. The tape measure according to claim 1, wherein the optical coding (2) is formed by specifically disposed and/or formed warp threads (4b) which extend longitudinally to the tape-measure length and/or weft threads (4a) which extend along the tape-measure width (B).

6. The tape measure according to claim 5, wherein the specifically disposed and/or formed warp threads and/or weft threads (4a, 4b) of the coding (2) have a different structure and/or coloration than the remaining base body (1) of the tape measure.

7. The tape measure according to claim 1, wherein the optical coding (2) is printed or glued on the base body (1).

8. The tape measure according to claim 1, wherein the base body (1) has at least one pocket (5) for accommodating a reflective core element (6).

9. The tape measure according to claim 8, wherein the core element (6) is disposed in such a manner in the interior of the base body (1) that openings (3a, 3b) formed in the base body are covered by the core element (6).

10. The tape measure according to claim 1, wherein the tape measure (10) has a first surface (1a) and an opposite second surface (1b), the first and the second surface (1a, 1b) each having different coding.

11. The tape measure according to claim 10, wherein a core element (6) is disposed in the interior of the base body (1) between the first and second surface (1a, 1b), the core element (6) covering openings (3a, 3b) formed in the first and second surface (1a, 1b).

12. The tape measure according to claim 1, wherein the tape measure (10) is single or double-layered.

13. The tape measure according to claim 1, wherein the coding (2) is disposed on a surface (1a, 1b) of the tape measure (10) in at least two lanes (7a, 7b).

14. The tape measure according to claim 1, wherein the coding (2) forms an alternating, sequential or absolute position coding.

15. The tape measure according to claim 1, wherein the base body (1) has a functionality and/or signal line (8) weaved or knitted along the length (L) and formed to not absorb force.

16. The tape measure according to claim 1, wherein the base body (1) has several pockets (5) which are disposed regularly along the tape-measure length and are formed for accommodating a core element (6) and/or a different information carrier.

17. A measuring system comprising a tape measure (10) according to claim 1 and a sensor arrangement (20) comprising an optical sensor (21) for reading the optical coding (2) of the tape measure (10).

18. The measuring system according to claim 17, wherein the sensor arrangement (20) has at least two optical sensors (21a, 21b) disposed at an offset to each other along the tape-measure length (L).

19. The measuring system according to claim 17, wherein the sensor arrangement (20) comprises at least two optical sensors (21, 21′) for reading a coding on a first and second surface (1a, 1b) of the tape measure (10).

20. The measuring system according to claim 17, wherein the optical sensor (21) of the sensor arrangement (20) has a light source and camera registration elements.

21. An elevator system having an elevator shaft (41) and an elevator car (42) displaceable therein and having a measuring system (30) for determining the position of the elevator car (42) in the elevator shaft (41) according to claim 17.

22. The tape measure according to claim 1, wherein the tape measure extends across at least two floors (43a, 43b, 43c, 43d).
